(19) United States
(12) Patent Application Publication
(10) Pub. No.: US 2007/0104563 A1
(43) Pub. Date: May 10, 2007

(54) Materials handling system

(76) Inventor: Brian L. Hamm, Middlesex (GB)

Correspondence Address: BLANK ROME LLP, 600 NEW HAMPSHIRE AVENUE, N.W., WASHINGTON, DC, 20037, US

(21) Appl. No.: 10/573,325

(22) PCT Filed: Sep. 24, 2004
(86) PCT No.: PCT/GB04/04068

§ 371 Date: Dec. 28, 2006

(30) Foreign Application Priority Data
Sep. 24, 2003 (GB) 0322406.0

(51) Int. Cl. B65G 67/02

(52) U.S. Cl. 414/572

(57) ABSTRACT

A materials handling system comprising, a mobile work station and a self propelled tug, said mobile workstation having a roller conveyor supported on a workstation chassis, said chassis having castors engageable with a floor and a tow bar extending from at least one of a side or end of said chassis, said tug having a body mounted on at least three ground engageable wheels and a tow bar hitch adapted to couple with said extended tow bar such that the rotary axis of at least one of the tug wheels is at least as close to the workstation chassis as the tow bar.

The present invention concerns a system for transporting loads within a warehouse, particularly but not exclusively air cargo loads to be made up for transport on aircraft. Such loads are commonly made up in warehouses before being loaded onto a truck for transport to the aircraft where it is loaded into the hold. The system is equally applicable to the reverse operation of receiving loads from aircraft and breaking them down before they are forwarded to their next destination.

The loads in question are commonly of the order of 5-8 metric tonnes. Loads comprising a palette (or cargo platform) or air cargo container and cargo are made up in the warehouse at a static workstation on a palette or in a container. The workstation commonly communicates with a roller bed conveyor whereby the load can be transported from the workstation to a truck dock. The truck dock provides a lift whereby the load can be elevated to the height of the truck bed of a truck parked in a truck parking bay. The truck dock also provides a roller conveyor that allows the load to be displaced laterally in the truck dock to align it accurately with the truck bed before being discharged onto the truck bed. A truck dock is conventionally a large fixed structure requiring significant civil engineering works to install and is consequently expensive and permanently obstructs an access to the warehouse.

In some warehouses the roller conveyor may be replaced by an elevating travelling vehicle (ETV) such as the Combi Cargo Manager™ able to support and transport the load around warehouse passageways. These provide greater versatility than the fixed roller conveyors but the large loads require additional manpower to transfer from idle roller conveyors, a qualified operator is required and their size necessarily requires large passageways.

It is also often necessary to provide the fixed workstation with an elevator so that the load can be raised from floor height to that of the roller table which conventionally operates at a roller table plane of 508 mm. As with the truck dock this is usually achieved using a scissorlift, which requires civil works upon installation and permanently occupies floor space. The height at which conventional roller tables and workstations operate also imposes limitations on the use of warehouse space due to safety and other constraints on the maximum height of the loads which can be built up.

It is generally desirable to reduce the manpower required for materials handling systems of this type, to reduce the floor space required and to enhance the flexibility of such systems.

It is an object of the present invention to provide a system which alleviates at least some of the aforementioned disadvantages of the prior art.

Accordingly there is provided a materials handling system comprising, a mobile work station and a self propelled tug, said mobile workstation having a roller conveyor supported on a workstation chassis, said chassis having castors engageable with a floor and a tow bar extending from at least one of a side or end of said chassis,

said tug having a body mounted on at least three ground engageable wheels and a tow bar hitch adapted to couple with said extended tow bar such that the rotary axis of at least one of the tug wheels is at least as close to the workstation chassis as the tow bar.

According to a second aspect of the present invention there is provided a materials handling system comprising a mobile work station and a self propelled tug, said mobile workstation having a roller conveyor supported on a workstation chassis, said chassis having castors engageable with a floor,

said roller conveyor having a transmission whereby power may be transmitted from a drive coupling to at least one of the rollers of the conveyor, said drive coupling being disposed on an end or side of the mobile workstation to engage with a complementary drive coupling provided on the tug so that when coupled to the tug the roller conveyor can be powered to power a load on to or off of the workstation.

According to a third aspect of the present invention there is provided a materials handling system comprising a mobile work station and a self propelled tug, said mobile workstation having a roller conveyor supported on a workstation chassis, said chassis having castors engageable with a floor, said chassis comprising elongate side members connected at each end by laterally extending end members and a plurality of laterally extending strengthening beams extending between the side members at longitudinally spaced intervals which support an overlying roller conveyor,

a plurality of floor engaging castors disposed adjacent one end of the workstation and arranged to rotate about a common axis such that only a segment of the roller of each castor projects clear of the end and side members to engage the floor whereby the workstation can support loads of between 5 and 9 metric tonnes but presents a roller conveyor plane of between 180 mm and 230 mm.

According to a fourth aspect of the present invention there is provided a truck dock comprising a chassis supporting an elevator, said elevator being adapted to receive a mobile workstation and elevate the workstation between floor height and the height of a truck bed, said truck dock chassis being mounted on floor engaging wheels which in normal use, when situated in a warehouse door, allow the truck dock to be moved laterally to align a load with a truck bed and also allow the truck dock to be moved away from the warehouse door.

A materials handling system constructed in accordance with the present invention will now be described, by way of example only, with reference to the accompanying illustrative drawings, in which:

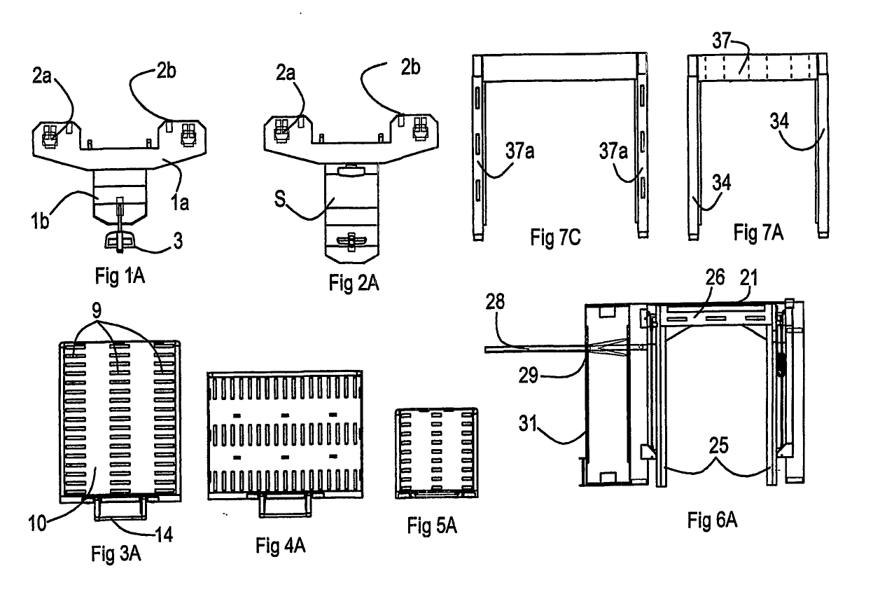

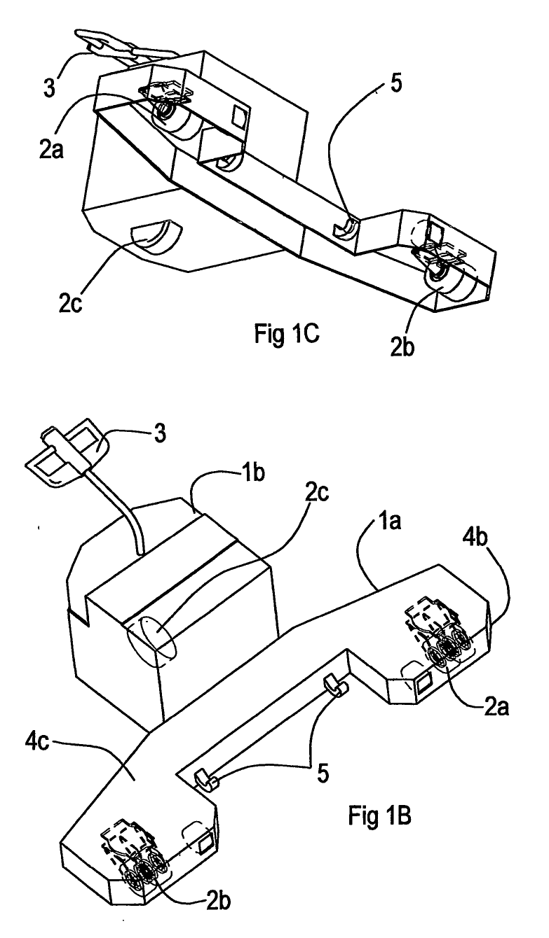

FIG. 1A is a plan view of a first tug embodiment for use in the system,

FIG. 1B is a perspective view from above and to one side of the tug in FIG. 1A,

FIG. 1C is a perspective view from below and to one side of the tug in FIG. 1A,

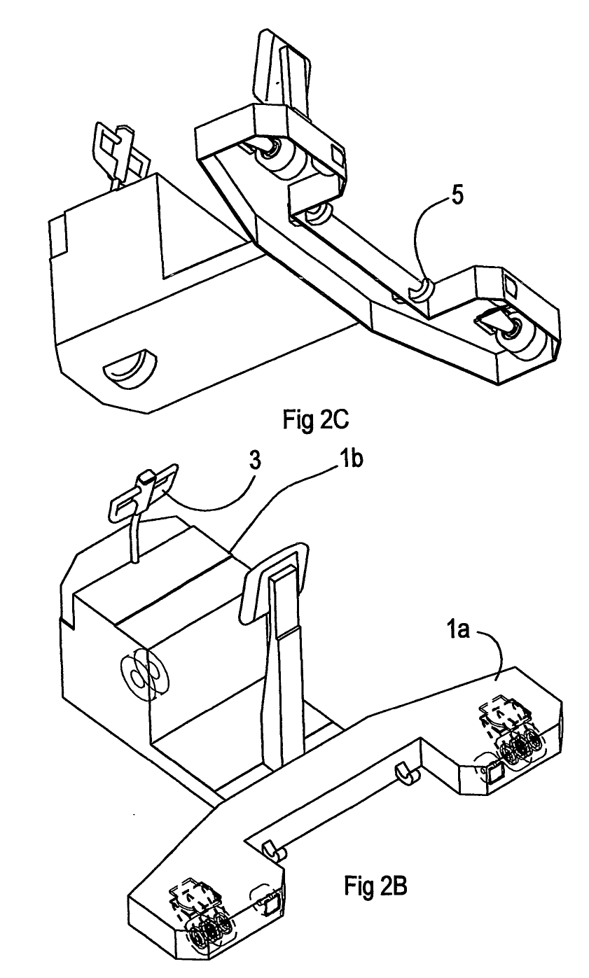

FIG. 2A is a plan view of a second embodiment of a tug for use in the system,

FIG. 2B is a perspective view from above and to one side of the tug in FIG. 2A,

FIG. 2C is a perspective view from below and to one side of the tug in FIG. 2A,

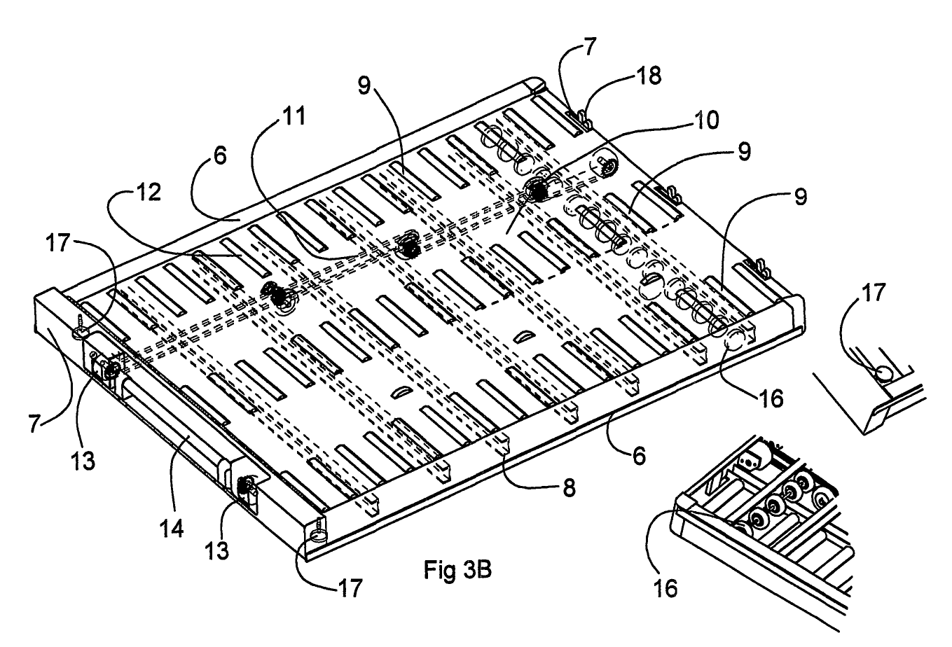

FIG. 3A is a plan view of a first embodiment of a mobile workstation,

FIG. 3B is a perspective view of the first embodiment of the workstation showing hidden detail,

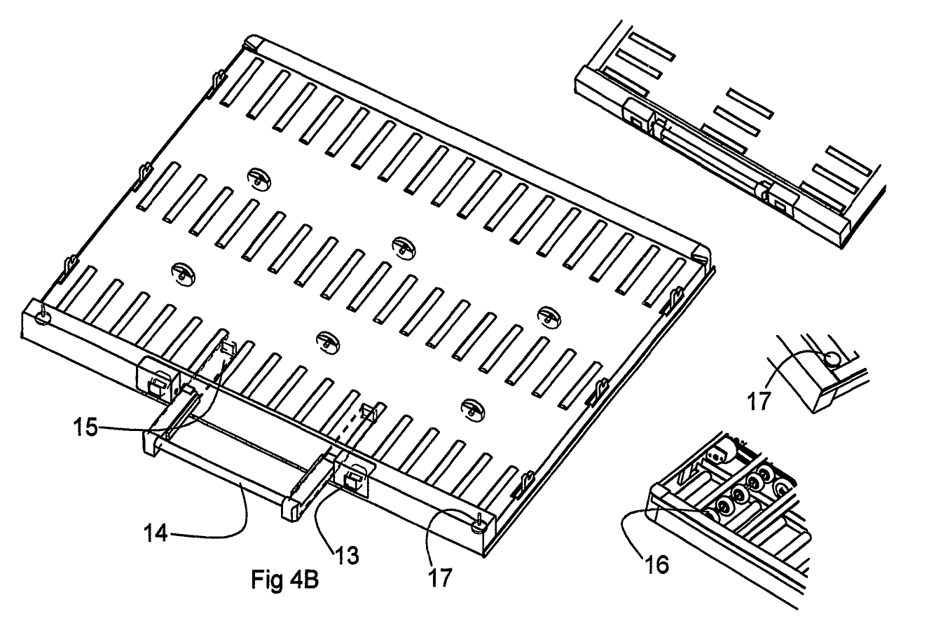

FIG. 4A is a plan view of a second embodiment of a mobile workstation,

FIG. 4B is a perspective view of the second embodiment of the mobile workstation showing hidden detail,

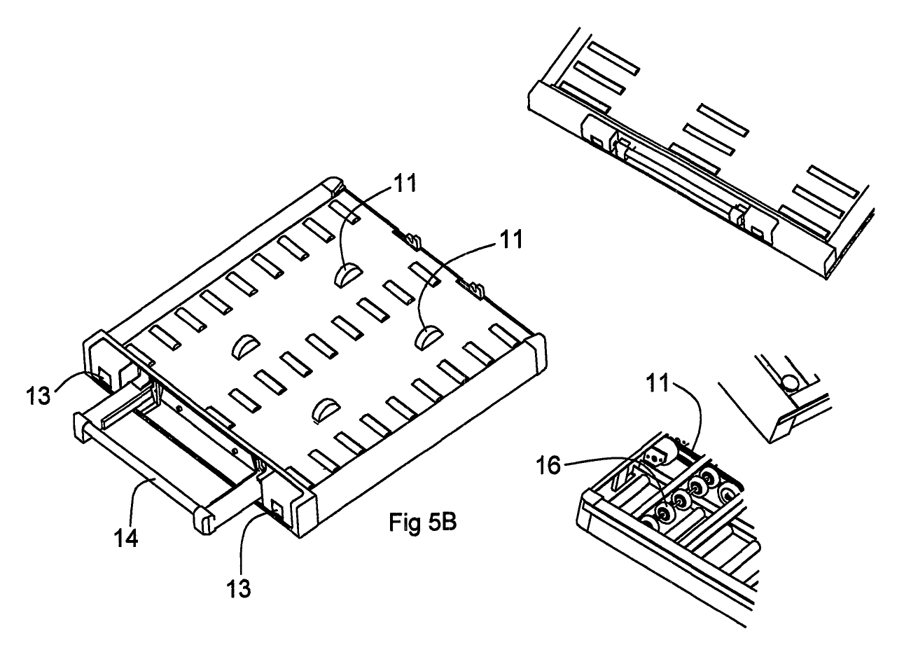

FIG. 5A is a plan view of a third embodiment of a mobile workstation,

FIG. 5B is a perspective view of the third embodiment of the mobile workstation showing hidden detail,

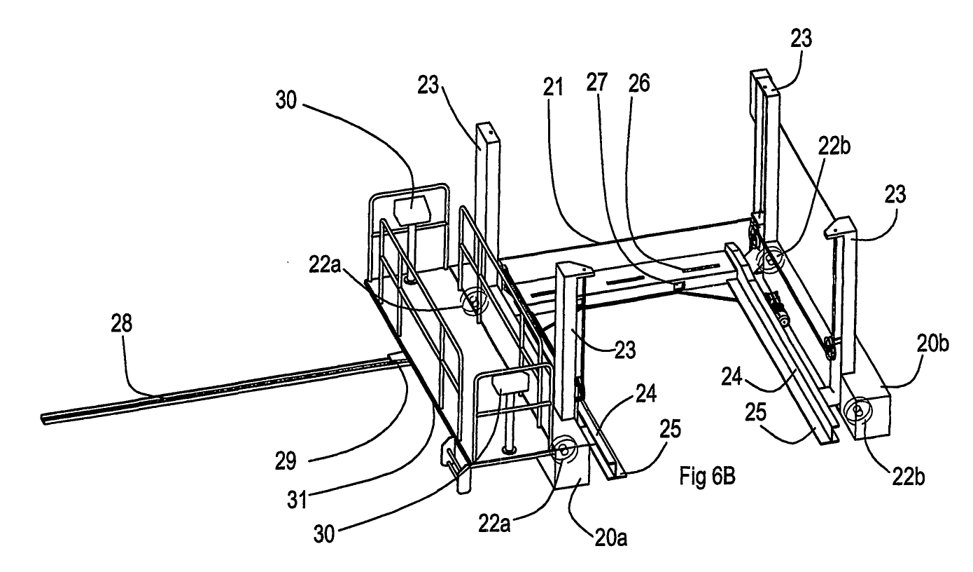

FIG. 6A is a plan view of a truck dock,

FIG. 6B is a perspective view of the truck dock showing hidden detail,

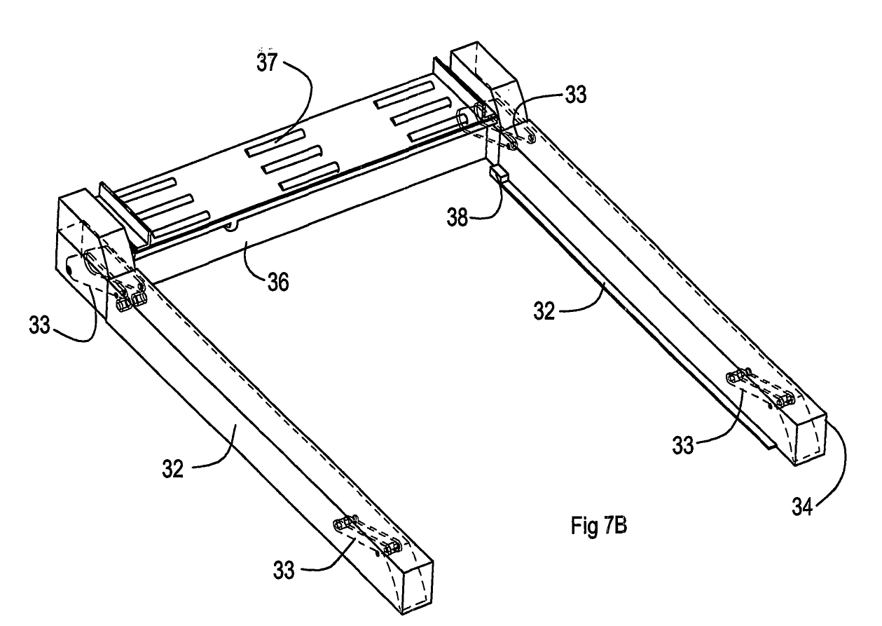

FIG. 7A is a plan view of a docking station and

FIG. 7B is a perspective view of a docking station.

Referring to the drawings, FIGS. 1A, B and C show views of a first embodiment of a self powered tug which is intended to be guided by a pedestrian operator. FIGS. 2A, B and C show views of a self powered tug generally similar to that in FIG. 1 but having a seat, saddle or deck (S) for the operator to ride on. The tug has a chassis 1 with a front section 1a which supports a pair of front wheels 2a and 2b and a rear section 1b which supports a motor for propulsion (not shown). The rear section also mounts a rear propulsion wheel 2c to be driven by the motor, which serves to steer the tug according to the position of a tiller 3. The rear section also accommodates the power supply for the tug which will ordinarily be batteries to power an electric motor. The front section 1a has wings 4a and 4b extending laterally one each to either side of the rear section 1b. The wings 4a and 4b also extend forwards of an intermediate part 4c of the front section so that the front wheels 2a and 2b can be spaced well away from the centre line of the tug for stability. The intermediate section 4c incorporates a tow hitch comprising a pair of laterally spaced hooks 5. The front wheels 2a and 2b are each mounted to rotate about an axis further from the rear section 1b of the tug than the axis of engagement of the hooks 5.

FIGS. 3, 4 and 5 each show variants of a mobile workstation. Each workstation comprises a rigid chassis formed primarily from a pair of longitudinally extending side members 6 and a pair of laterally extending end members 7 all of “U” section or box section and secured together to form a rigid rectangular structure. Additional strengthening beams 8 extend laterally between the side members at longitudinally spaced intervals.

The top of the work station is an arrangement of three roller conveyors 9 each extending longitudinally from the front of the workstation (to the left in FIG. 3B) to the rear (to the right in FIG. 3B). Each of the roller conveyors is separated by a longitudinally extending walkway 10. Each roller conveyor 9 is powered by a pair of belt drive transmissions 11 which via a series of coupled belts, convey power to drive the rollers 12 of the roller conveyer to allow a load to be drawn onto or off of the workstation. Each of the transmissions is coupled one each to each of a pair of laterally spaced friction rollers 13 mounted in the front end member 7 so that the rim of each friction roller 13 projects from the side of the member to form a drive coupling. A similar pair of friction rollers (not shown) may be provided in the rear member 7.

A laterally extending tow bar 14 is mounted on longitudinally extending guide rails 15 formed into the chassis. A recess is provided in the member 7 so that the tow bar can be set flush with the side of the chassis in one position and drawn out as illustrated in FIGS. 4B and 5B to an extended position. It will be appreciated that the mounting of the tow bar in the chassis is rigid to the extent required to prevent articulation or flexing in the vertical direction.

On the underside of the chassis adjacent the rear member 7 are disposed a plurality of ground engaging castors 16 each mounted to rotate on a common laterally extending axis. It is desirable that a large number of castors are mounted on the axis in order to disperse the load applied to the floor, and to this end sixteen castors have been used in the example of FIG. 3B. The number of castors used will vary according to the duty required. Using a large number of castors also has the benefit of allowing the roller table plane height to be kept to a minimum.

A pair of ground engageable feet 17 are mounted one each at each front corner of the chassis to provide ground engageable elements. When at rest the ground engaging feet support and brake the workstation. Palette stops 18 are also provided at the front and rear of the workstation.

The variant of the workstation shown in FIG. 4 has the tow bar extensible from the side member 8 with the castors 16 and feet appropriately repositioned. The combination of the variants of FIGS. 3A and 3B is contemplated with a workstation having tow bars extensible from each of the front and the side and arrays of castors positioned on axis at the opposite end and side of the workstation. These variants present advantages in maneuvering the workstation in some confined warehouse environments.

The variant shown in FIG. 5 is intended for smaller loads and so does not include a powered roller conveyor.

The tug is coupled to the workstation by extending the tow bar 14 and then driving the tug up to the front end of the workstation so that the tow bar is received into the recess formed between the sections 4 to overly the axis of the hooks 5. The hooks 5 are then raised via a raising mechanism such as hydraulics or worm drives (not shown) provided in the tug to engage and lift the tow bar so that the feet 17 are raised clear of the ground. It is important that the location of the tow bar axis is closer to the rear section 1b of the tug then the front wheel axis, and hence when coupled to the workstation the tow bar axis and the weight of the workstation is further from the workstation than the front wheels of the tug so that the weight of the tug can be safely supported by the tug. Further the tow bar is laterally between the front wheels 2a, 2b so that the load is laterally stable. This permits the tug workstation combination to tow large loads of the order of 5 to 9 metric tonnes. The workstation can now be towed around the warehouse as required. It is also beneficial that the tug requires only three wheels.

The hooks 5 are shaped with an inclined surface so that when raised in engagement with the tow bar 14 the tow bar and hence the workstation are urged towards each other. As can readily be seen in FIG. 1B the tug has a pair of friction drive rollers 18 mounted one each in the front of each wing section 4a and 4b so that when the workstation is coupled to the tug the friction rollers 13 bear against the friction rollers 18. Friction rollers 18 are coupled via a transmission (not shown) to the tug's motor drive, so that the tug can provide power to drive the roller conveyor of the workstation.

Because the workstation has a low profile it can be used as a floor standing workstation when disengaged from the tug. Alternatively it may be used in combination with an elevating station. Loads such as pallets or containers can conveniently be drawn onto the workstation from a roller table by use of the powered roller conveyor either at an elevating workstation or at a truck dock.

A truck dock in accordance with the invention is shown in FIGS. 6A and 6B. A truck dock is conventionally mounted in a door of a warehouse facility and provides an interface between trucks with delivery loads to the warehouse and the conveyor workstation and other conveyor storage facilities in the warehouse. They are necessary because the elevation of any truck bed varies according to the nature of the truck and to a degree how it is loaded. Apart from vertical alignment (elevation) of the load it is also commonly necessary to adjust the lateral alignment of the load going onto or off of a truck, which facility is conventionally provided for by a roller conveyor on the truck dock. Conventional truck docks require substantial civil works which permanently obstruct the warehouse door. The truck dock shown in FIG. 6 is used in combination with the previously described tug and workstation.

The truck dock in FIG. 6 consists of a “U” shaped chassis having two similar substantially parallel side members 20a and 20b connected together by an end member 21. The two side members 20 are each mounted on pairs of floor engaging wheels 22a and 22b respectively. The end member 21 is disposed towards the truck end of the truck dock and ensures that the structure is sufficiently rigid to keep four elevator towers 23 upright. The elevator towers 23 support an elevator assembly comprising a pair of longitudinally extending elevator parts 24 extending in opposition to each other adjacent the side members 20 to leave a clear floor space large enough to accommodate a workstation such as that described above between them (the elevator bay). Each of the elevator parts 24 includes a projecting part provided by a flange 25 which projects parallel to and adjacent the floor and may be capable of resting on the floor so that the side members 6 of a workstation received into the elevator bay overlie the flanges.

The truck end of each elevator part 24 is connected by a narrow roller conveyor 26 with a motor (not shown) provided to power the roller conveyor 26. A pair of friction rollers 27 project from the workstation bay side of the roller conveyor 26 and are disposed to couple with the friction rollers 13 provided on the rear end of the workstation. Means is provided to urge the friction rollers of the workstation and truck dock together and may comprise powered clamps (not shown) mounted on the end of the parts 24 to engage the front corners of a workstation.

A track 28 is mounted onto or into the floor and is engaged by a guide runner 29 mounted onto the chassis 20.

In use with a workstation and tug as described above the tug may tow and/or push the workstation into the workstation bay with the elevator assembly lowered. The urging means are actuated on the truck dock to engage the front corners of the workstation chassis and urge the friction rollers to couple. The tug will disengage the hooks 5 and can be driven away for other tasks. The elevator assembly is then raised via the action of hydraulic or electric motors during which operation a self levelling assembly ensures that the elevator assembly remains horizontal. The operator controls this aspect of the operation from one of two control consoles 30 mounted one each towards each end of an operator platform 31 cantilever supported off the chassis 20 to one side of the chassis. When the workstation is elevated to the height of the truck bed of a truck parked on the truck side of the truck dock, the operator checks and adjusts the lateral alignment of the load with the truck bed. If adjustment is required, the wheels 22 are powered and guided to move the entire truck dock laterally to the left or right as required until alignment is achieved.

When alignment is achieved the operator actuates a roller conveyor drive in the lift assembly which simultaneously drives the roller conveyor 26 and via the friction roller coupling 27 with friction rollers 13 the roller conveyor of the workstation so that the load on the workstation is urged towards the truck bed. It will be apparent that this operation can be reversed when taking loads into the warehouse.

In the event that the door in which the truck bed is located is required to provide access to the warehouse by large machinery, the truck dock can readily be displaced out of the way by virtue of the wheels 22 which are preferably powered by an onboard motor.

FIG. 7 show a docking station for use in combination with the workstation and tug described above to provide an interface with conventional roller conveyors from the 200 mm workstation roller lane height to the 508 mm roller plane height which is conventional. The docking station comprises a “U” shaped floor mounted chassis, which will commonly be bolted to the floor. The chassis has a pair of longitudinally extending “U” section parallel arms 32. Each of the arms 32 accommodates a parallelogram lifting mechanism 33 which engages an overlying “U” section elevating member 34. The elevating member 34 envelopes the associated arm 32 so that a shelf part 35 projects from the lower edge of the elevating member 34 adjacent the floor. The rear ends of the parallel arms 32 are connected via a lateral chassis member 36 which is hollow to accommodate the motors to drive the parallelogram lift. The lateral member 36 also supports a powered roller conveyor 37 at a height of 508 mm which is intended to communicate with conventional 508 mm roller conveyors. In use a low profile 200 mm workstation such as that described above can be driven into the workstation bay formed between the opposing elevating members 34 so that the side members 7 of the workstation overly the shelves 35. The front end member of the workstation will abut stops 38 formed on the shelves 35 before the tug will release the workstation. The parallelogram elevator is then actuated to raise the workstation. An advantage of the parallelogram elevator is that it not only raises the workstation but also urges the drive couplings 13 on the front of the workstation into engagement with corresponding drive couplings (not shown) formed on the opposing edge of the roller conveyor 37. Thus at the elevated height the roller conveyors 37 and 9 can be powered to drive a load on or off of the workstation.

FIG. 7C shows a variant of the docking station for use with the workstation of FIG. 4A. The variant docking station has roller tables 37a mounted on the elevating members 34 so that the docking station could be installed between two lengths of conventional roller conveyor.

1. A materials handling system comprising, a mobile work station and a self propelled tug, said mobile workstation having a roller conveyor supported on a workstation chassis, said chassis having castors engageable with a floor and a tow bar extending from at least one of a side or end of said chassis,
said tug having a body mounted on at least three ground engageable wheels and a tow bar hitch adapted to couple with said extended tow bar such that the rotary axis of at least one of the tug wheels is at least as close to the workstation chassis as the tow bar.

2. A system according to claim 1 wherein the workstation wheels are all mounted to rotate on a single axis located at the side or end of the workstation chassis remote from the tow bar, said workstation chassis having ground engageable supports towards the side or end near the tow bar and said tow bar hitch acting to lift said tow bar and hence the tow bar end of said chassis such that when free standing the workstation is braked by the ground engageable supports and engaged with the floor, and when the tow hitch is coupled to the tow bar the ground engageable supports are raised clear of the ground so that the tub can propel the workstation supported on the wheels and castors.

3. A system according to claim 1 wherein the tow bar is extensible from a position substantially flush with the side of the chassis.

4. A system according to claim 1 wherein the roller table includes a drive transmission to drive at least some of the rollers, said drive transmission having a drive coupling to co-operate with a corresponding drive coupling provided on the tug whereby the tug provides the power to drive the roller conveyor.

5. A system according to claim 4 wherein the coupling comprises at least one friction drive roller provided on the mobile workstation chassis and arranged to engage a complementary friction drive roller arranged on the self propelled tug.

6. A system according to claim 4 having an elevating truck dock, said elevating truck dock having a drive coupling arranged to co-operate with the coupling of the mobile workstation to provide power to the roller conveyor.

7. A system according to claim 6 wherein the coupling is provided by a friction drive roller.

8. A system according to claim 1 including an elevating truck dock, said elevating truck dock comprising a free standing chassis mounted on ground engaging wheels whereby the truck dock can be moved out of the way of an access door of a warehouse.

9. A system according to claim 8, wherein the truck dock is provided with a floor mounted guide rail to guide the truck dock to move laterally in order to align a load with the truck bed of a truck when receiving or discharging the load.

10. A system according to claim 8 wherein the truck dock includes an elevator assembly supported by the truck dock chassis, said elevator assembly having a pair of parallel elevator beams extending one each to either side of a work station bay and having parts projecting laterally to engage beneath the sides of the chassis of a workstation driven into the work station bay.

11. A system according to claim 1 and as herein described with reference to the accompanying figures.

12. A materials handling system comprising a mobile work station and a self propelled tug, said mobile workstation having a roller conveyor supported on a workstation chassis, said chassis having castors engageable with a floor,
said roller conveyor having a transmission whereby power may be transmitted from a drive coupling to at least one of the rollers of the conveyor, said drive coupling being disposed on an end or side of the mobile workstation to engage with a complementary drive coupling provided on the tug so that when coupled to the tug the roller conveyor can be powered to power a load on to or off of the workstation.

13. A materials handling system comprising a mobile work station and a self propelled tug, said mobile workstation having a roller conveyor supported on a workstation chassis, said chassis having castors engageable with a floor, said chassis comprising elongate side members connected at each end by laterally extending end members and a plurality of laterally extending strengthening beams extending between the side members at longitudinally spaced intervals which support an overlying roller conveyor,
a plurality of floor engaging castors disposed adjacent one end of the workstation and arranged to rotate about a common axis such that only a segment of the roller of each castor projects clear of the end and side members to engage the floor whereby the workstation can support loads of between 5 and 9 metric tonnes but presents a roller conveyor plane of between 180 mm and 230 mm.

14. A materials handling system comprising a truck dock comprising a chassis supporting an elevator, said elevator being adapted to receive a mobile workstation and elevate the workstation between floor height and the height of a truck bed, said truck dock chassis being mounted on floor engaging wheels which in normal use, when situated in a warehouse door, allow the truck dock to be moved laterally to align a load with a truck bed and also allow the truck dock to be moved away from the warehouse door.
